(19) United States
(12) Patent Application Publication
(10) Pub. No.: US 2012/0048173 A1
(43) Pub. Date: Mar. 1, 2012

(54) Adjustable Gunnel Pad Apparatus and Method

(76) Inventor: Joe H. Todd, Evans, GA (US)

(21) Appl. No.: 13/224,312

(22) Filed: Sep. 1, 2011

Related U.S. Application Data
(60) Provisional application No. 61/379,376, filed on Sep. 1, 2010.
(60) Provisional application No. 61/529,903, filed on Aug. 31, 2011.

(51) Int. Cl. B63B 17/00; B23P 11/00

(52) U.S. Cl. 114/361; 29/428

(57) ABSTRACT

An adjustable gunnel pad may include a top portion comprising a top surface of a boat gunnel, a first leg portion comprising a first extension/retraction portion, and second leg portion comprising a second extension/retraction portion. The first leg portion and the second leg portion are connected via the top portion. In certain embodiments, the first and second extension/retraction portions may each comprise a motor, a tiered portion, and/or a pin-based portion.

### CROSS-REFERENCE TO RELATED APPLICATIONS

This application claims the benefit of priority from U.S. Provisional Patent Application Ser. No. 61/379,376 (filed Sep. 1, 2010) and 61/529,903 (filed Aug. 31, 2011). The entire contents of Provisional Patent Application Ser. Nos. 61/379,376 and 61/529,903 are explicitly incorporated herein by reference in their entirety.

### STATEMENT REGARDING FEDERALLY SPONSORED RESEARCH OR DEVELOPMENT

Not Applicable.

### FIELD OF THE INVENTION

This invention relates generally to aquatic transports. More specifically, the present invention is directed to adjustable boat gunnel apparatuses and methods.

### BACKGROUND OF THE INVENTION

Current aquatic technologies include a variety of human transports, including bay boats and offshore boats. Bay boats are often preferred for calmer, shallower waters, whereas offshore boats are often preferred for deeper, rougher waters. Such preferences are due, at least in part, to the lower gunnel heights of bay boats and higher gunnel heights of offshore boats.

Gunnel height can not only affect a boat's performance, but also can affect passenger safety as well under certain conditions. For instance, the relatively low gunnel height of a bay boat can make for a light vessel that performs well in shallower waters; however, the relatively low gunnel height can also make the bay boat unfit for deeper, rougher waters because of passenger safety issues. Conversely, while the relatively high gunnel height of the offshore boat can make it more appropriate for rougher, deeper waters, it can also make for a heavier vessel that does not perform as well in shallower waters.

### SUMMARY OF THE INVENTION

The present invention has been developed in response to the present state of the art, and in particular, in response problems and needs that have not yet been adequately recognized or resolved.

In one embodiment of the present invention, an apparatus includes a top portion of a boat gunnel pad, a first leg portion having a first extension/retraction portion, and a second leg portion having a second extension/retraction portion. The first leg portion and the second leg portion can be connected via the top portion.

In certain embodiments, the first extension/retraction portion includes a first motor and the second extension/retraction portion includes a second motor. In some embodiments, the first extension/retraction portion includes a first tiered portion and the second extension/retraction portion includes a second tiered portion. In additional embodiments, the first extension/retraction portion includes a first pin-based portion and the second extension/retraction portion includes a second pin-based portion.

In certain embodiments, the first extension/retraction portion and the second extension/retraction portion are connected to the boat gunnel. In some embodiments, the first extension/retraction portion and the second extension/retraction portion are connected to a boat floor. In some embodiments, a first handle may activate the first extension/retraction portion and a second handle may activate the second extension/retraction portion.

In another embodiment of the present invention, a method includes elevating the top portion of a boat gunnel pad, securing extension/retraction portion of the gunnel pad, disengaging the extension/retraction portion of the gunnel pad, and lowering the top portion of the gunnel pad.

In certain embodiments, the elevating of the top portion of the gunnel pad includes activating a motor of the gunnel pad. In some embodiments, the elevating of the top portion of the gunnel pad includes applying an operator-generated, upward force on a tiered portion of the gunnel pad. In additional embodiments, the elevating of the top portion of the gunnel pad may include removing a spring-biased pin from a pin-based portion of the gunnel pad.

In certain embodiments, the securing of the extension/retraction portion includes deactivating a motor of the gunnel pad. The securing of the extension/retraction portion may also include eliminating an operator-generated, upward force on the tiered portion of the gunnel pad. In some embodiments, the securing of the extension/retraction portion may include reintroducing a spring-biased pin into a pin-based portion of the gunnel pad. The securing of the extension/retraction portion may also include the use of one or more gunnel pad handles that are operatively connected to a pin in the pin-based portion of the gunnel pad.

### BRIEF DESCRIPTION OF THE DRAWINGS

A more particular description of the present invention will now be rendered by reference to the appended Figures. These Figures depict only some embodiments of the invention and are not limiting of its scope. Regarding the Figures:

FIGS. 1a and 1b are perspective views of a boat in accordance with one or more embodiments of the present invention;

FIG. 2 is a perspective view of a motorized gunnel pad in accordance with one or more embodiments of the present invention;

FIG. 3 is a perspective view of a tiered gunnel pad in accordance with one or more embodiments of the present invention;

FIGS. 4a-4b are perspective views of pin-based gunnel pads in accordance one or more embodiments of the present invention;

FIG. 5 is a flow chart diagram of a gunnel pad adjustment method in accordance with one or more embodiments of the present invention; and

FIG. 6 is a perspective view of an after market gunnel pad in accordance with one or more embodiments of the present invention.

FIG. 7 is a front view of a leg portion in accordance with one or more embodiments of the present invention.

FIG. 8 is a front view of a bracket with an extension rod and a receiving sleeve therein in accordance with one or more embodiments of the present invention.

FIG. 9 is a partial view of the bracket of FIG. 8 in accordance with one or more embodiments of the present invention.

FIG. 10 is a perspective front view of a bracket with an extension rod and a receiving sleeve therein in accordance with one or more embodiments of the present invention.

FIG. 11 is a perspective front view of a leg portion in accordance with one or more embodiments of the present invention.

FIG. 12 is a sideways view of a bracket with an extension rod and a receiving sleeve therein in accordance with one or more embodiments of the present invention.

FIG. 13 is a further sideways view of a bracket with an extension rod and a receiving sleeve therein in accordance with one or more embodiments of the present invention.

FIG. 14 is a top view of a bracket with an extension rod and a receiving sleeve therein in accordance with one or more embodiments of the present invention.

FIG. 15 is a partial cut-away top view of a bracket with an extension rod and a receiving sleeve therein in accordance with one or more embodiments of the present invention.

### DETAILED DESCRIPTION OF PREFERRED EMBODIMENTS

The present invention is directed to aquatic transports. More specifically, the present invention is directed to adjustable boat gunnel apparatuses and methods.

The following description and accompanying Figures demonstrate that the present invention may be practiced or implemented in a variety of embodiments. The discussion of these embodiments amounts to a complete written description that enables those of ordinary skill in the art to make and use the invention. While several embodiments are expressly disclosed herein, it should be appreciated that the present invention is not limited to the specifically disclosed embodiments. Indeed, the structures, features, operations or functions of the described embodiments may be reorganized or reconfigured to create one more embodiments that are not specifically discussed herein, but nevertheless fall within the scope the present invention.

Further, the use of words or phrases such as “certain embodiments,” “some embodiments,” “may,” “can,” or similar language means that a particular feature, structure, function, characteristic, or benefit described in connection with an embodiment is included in at least one embodiment of the present invention. Thus, appearances of “certain embodiments,” “some embodiments,” “may,” “can,” or similar language do not necessarily all refer to the same embodiment or group of embodiments and the described features, structures, functions, characteristics, or benefits may vary from one embodiment to another.

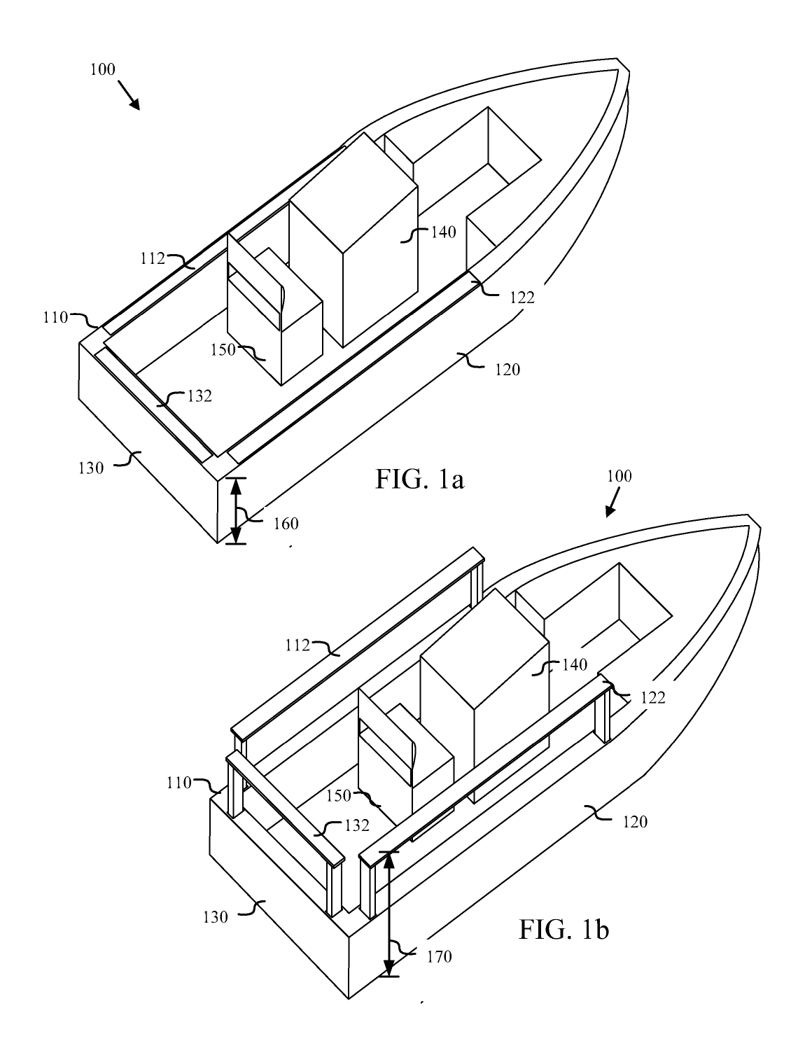

FIGS. 1a and 1b are perspective views of a boat 100 in accordance with one or more embodiments of the present invention. The depicted boat 100 includes a port side gunnel 110, a port side gunnel pad 112, a starboard side gunnel 120, a starboard side gunnel pad 122, a stern side gunnel 130, and a stern side gunnel pad 132. The boat 100 also includes a control console 140 and a seating area 150. In certain embodiments, the depicted boat 100 may be a bay boat.

In certain embodiments, the gunnel pads 112, 122, and 132 may be in a closed or retracted position, as depicted in FIG. 1a. In this position, the gunnel pads 112, 122, and 132 may be flush with the top of the boat gunnels 110, 120, and 130, and the functional height 160 of the gunnels may be relatively low. For instance, the functional height 160 of the gunnels may be approximately nineteen inches (19″). Having the gunnel pads 112, 122, and 132 in a closed position can enable the boat 100 to operate as a so-called bay boat.

In some embodiments, the gunnel pads 112, 122, and 132 may be in an extended or elevated position, as depicted in FIG. 1b. In this position, the functional height 170 of the gunnels is greater than the functional height 160 of the gunnels in the closed position. In fact, in some embodiments, the functional height 170 of the gunnels in the extended position may be approximately twenty-seven inches (27″). As such, some embodiments of the present invention enable a boat to benefit from the low gunnels of a bay boat and the passenger security of an offshore boat.

In certain embodiments, the boat 100 may include a greater number of gunnel pads. For instance, in some embodiments the gunnel pads 112 and 122 on the starboard and port sides, respectively, of the boat 100 may each be divided into two or more shorter gunnel pads for convenience, safety, performance, or versatility purposes. Alternatively, in some embodiments the boat 100 may include fewer gunnel pads. For instance, in some embodiments the boat 100 might not have stern side gunnel pad 132. Accordingly, the number and arrangement of gunnel pads in the present invention may vary in number, size, kind, and location.

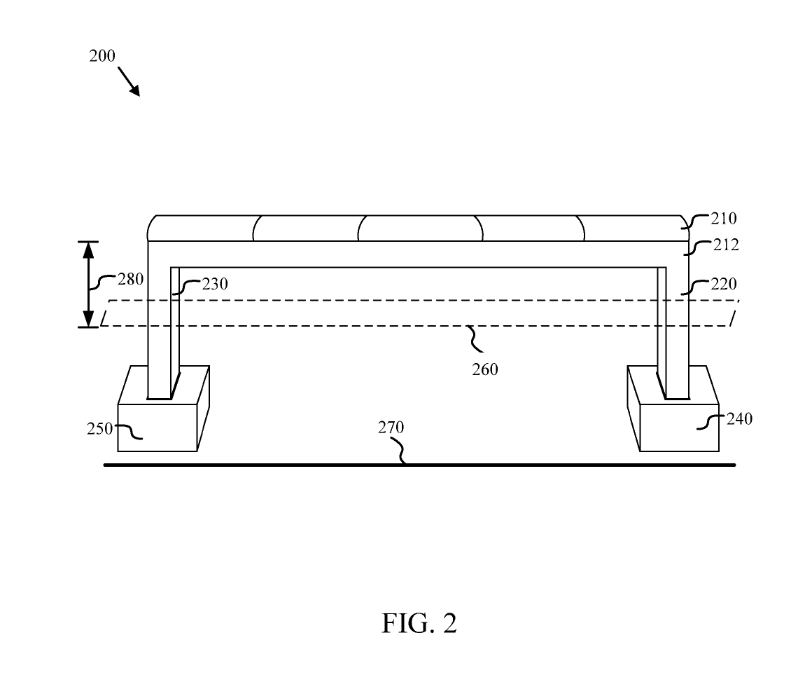

FIG. 2 is a perspective view of a motorized gunnel pad 200 in accordance with one or more embodiments of the present invention. The depicted gunnel pad 200 includes a top portion 210, a first leg portion 220, a second leg portion 230, a first motor 240, and a second motor 250. In certain embodiments, the motorized gunnel pad 200 corresponds to one or more of the gunnel pads of FIGS. 1a-1b.

In some embodiments, the top portion 210 is physically connected to the first and second leg portions 220 and 230. In certain embodiments, the top portion 10 and first and second leg portions 220 and 230 can be at least partially constructed from fiberglass, metal, wood, or other materials that are consistent boating and aquatic environments. In some embodiments, the top portion 210 includes one or more padded elements that include a padded portion on the top surface thereof. In certain embodiments, the first and second leg portions 220 and 230 are functionally connected to the first and second motors 240 and 250, and the first and second motors 240 and 250 can be positioned and/or secured on the boat floor 270 and/or gunnel 260. In some embodiments, the motors 240 and 250 can be activated to raise and lower the gunnel pad 200 in an automated fashion, represented by the distance 280. In some embodiments, the motors 240 and 250 may include an operator-accessible switch or button (not shown) for activating the motors 40 and 250. In certain embodiments, the motors 240 and 250 may be in communication with a boat console or control panel (not shown) so that a user or passenger can activate the motors 240 and 250 from the console or control panel. In certain embodiments, the motors 240 and 250 are configured to counter rotate a threshold rod (not shown) that is inside each of the first and second leg portions 220 and 230.

In some embodiments, the motors 240 and 250 are preconfigured with one or more specific heights. For instance, the motors 240 and 250 may be preconfigured with three heights that will position the padded top portion 210 at three inches (3″), five inches (5″), or eight inches (8″) above the gunnel 260. In such embodiments, a user may select or navigate to an appropriate height for the gunnel pad 200 depending on the given boating conditions. In other embodiments, the motors 240 and 250 may be configured without preset heights to enable the user to position the top portion 210 without constraint.

While the depicted gunnel pad 200 includes padded elements that mainly cover the top portion 210, other embodiments of the present invention may have padded elements in different locations. For instance, some embodiments may only include padded elements on an outer surface 212 of the gunnel pad 200 (i.e., a surface of the gunnel pad 200 that faces away from the boat). Similarly, other embodiments may only have padded elements on an inner surface (not shown) of the gunnel pad 200 a surface of the gunnel pad 200 that faces toward the boat).

In addition, the gunnel pad 200 may have padded elements on any combination of surfaces. For instance, some embodiments may include padded elements on the top portion 210 and the inner surface of the gunnel pad 200. Other embodiments may include padded elements on the top portion 210 and the outer surface 212 of the gunnel pad 200. In other yet embodiments, only the inner surface of the gunnel pad 200 may have padded elements.

In these and other embodiments, surfaces without padding may include or otherwise comprise of fiberglass, sheet metal, or any other material suitable for boating environments. In some embodiments, since passengers may lean against the gunnel pad 200, placing padded elements on at least the inner surface of the gunnel pad 200 may increase the level of comfort and overall utility enjoyed by boat passengers. Further, while the foregoing description of padded elements is presented reference to FIG. 2, it should be appreciated that the description is also applicable to the gunnel pads discussed elsewhere in this specification.

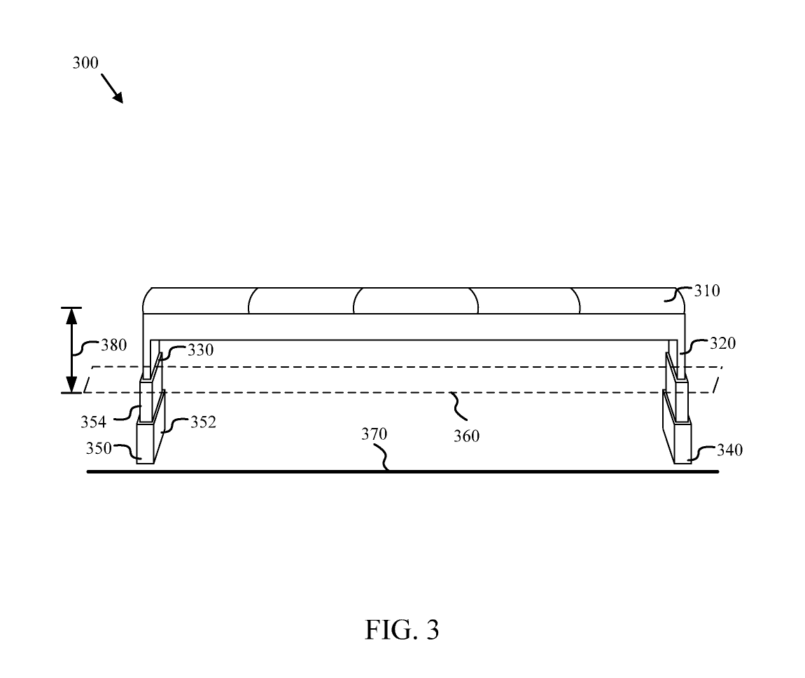

FIG. 3 is a perspective view of a tiered gunnel pad 300 in accordance with one or more embodiments of the present invention. The depicted gunnel pad 300 includes a top portion 310, a first leg portion 320, a second leg portion 330, a first tiered portion 340, and a second tiered portion 350. In certain embodiments, the tiered gunnel pad 300 corresponds to one or more of the gunnel pads of FIGS. 1a-1b.

Similar to the motorized gunnel pad of FIG. 2, the top portion 310 and lea portions 320 and 330 of FIG. 3 may be constructed from fiberglass, metal, wood, padding, and a variety of other materials commonly found in the field of boating. Also, the leg portions 320 and 330 may be physically connected to the tiered portions 340 and 350, which can be configured to enable a user or passenger to manually raise or lower the top portion 310 according to boating conditions. In certain embodiments, the first and second tiered portions 340 and 350 may be anchored or otherwise secured to the boat floor 370 or gunnel 360.

The first and second tiered portions 340 and 350 may include a variety of materials and dimensional characteristics that facilitate or enable the raising or lowering of the top portion 310. In certain embodiments, the dimensions of the tiered portions 340 and 350 are such that a user may expand or collapse the tiered portions 340 and 350 manually. In addition, the tiered portions 340 and 350 may be constructed of a coarse material, such as rubber, so there is enough friction between tiered portion segments 352 and 354 to maintain the height of the top portion 310, represented by the distance 380 between the top portion 310 and the gunnel 360. In such embodiments, the height or size of each segment 352 and 354 may operate to establish preset heights for the top portion 310 that correspond to one or more boating standard heights. Further, while the tiered portions 340 and 350 are depicted as being substantially rectangular in shape, it should be appreciated that the tiered portions 340 and 350 may implemented in a variety of different shapes such as circles, squares, triangles, or any other shape suitable to performing the functions of the tiered portions 340 and 350 described herein.

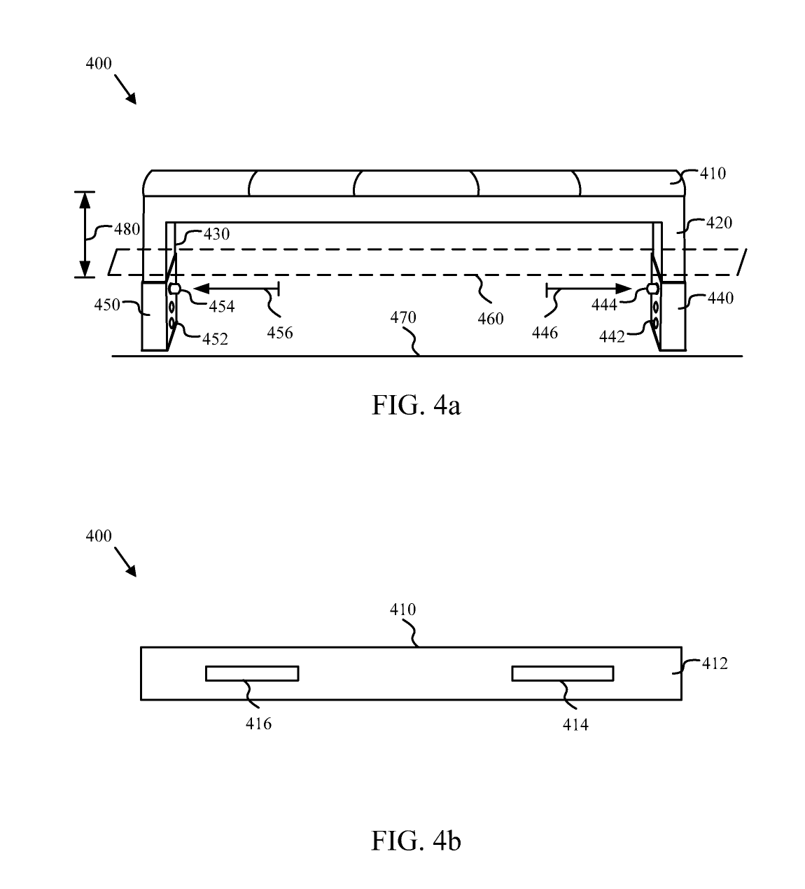

FIGS. 4a-4b are perspective views of a pin-based gunnel pad 400 in accordance with one or more embodiments of the present invention. The depicted gunnel pad 400 includes a top portion 410, a first leg portion 420, a second leg portion 430, a first pin-based portion 440, and a second pin-based portion 450. In certain embodiments, the pin-based gunnel pad 400 corresponds to one or more of the gunnel pads of FIGS. 1a-1b.

As with the embodiments of FIGS. 2-3, the top portion 410 and leg portions 420 and 430 of FIG. 4 may be constructed from fiberglass, metal, wood, padding, and a variety of other materials commonly found in the field of boating. In certain embodiments, the leg portions 420 and 430 are functionally connected to the first and second pin-based portions 440 and 450, such that each leg portion 420 and 430 may collapse into and expand out of their respective pin-based portions 440 and 450. The pin-based portions 440 and 450 may be secured or otherwise connected to the boat floor 470 or the gunnel 460.

In certain embodiments, the pin-based portions 440 and 450 may each include a pin 444 and 454, respectively, and one or more holes 442 and 452, respectively. In some embodiments, the pins 444 and 454 may be connected to a spring (not shown) or other force generating mechanism to bias the pins 444 and 454 against the pin-based portions 440 and 450. In such embodiments, an operator may secure the top portion 410 at a desired height 480 above the gunnel 460 by pressing the spring-biased pins 444 and 454 in an inward direction 456 and 446, moving the top portion 410 to the desired location, and allowing the spring-biased pins 444 and 454 to push through one of the pre-constructed holes 442 and 452 of the pin-based portions 440 and 450. In other embodiments, the pins 444 and 454 may be manually removable such that an operator may secure the top portion 410 at a given position by removing the pins 444 and 454 from the pin-based portions 440 and 450, moving the top portion 410 to a desired location that aligns one of the holes 442 and 452 (reordered for consistency with above) in the pin-based portions 440 and 450 with holes (not shown) in the corresponding leg portions 420 and 430, and reinserting the pins 444 and 454 into the aligned holes.

In some embodiments, handles 414 and 416 (see FIG. 4b) may also be used to raise and/or lower the top portion 410. In such embodiments, the handles 414 and 416 may be located on an underside or underbelly 412 of the top portion 410. The handles 414 and 416 may be in operative connection with the spring-biased pins 444 and 454 so that an operator may retract the spring-biased pins 444 and 454 by activating (pulling or pushing) the handles 414 and 416. Once the pins 444 and 454 are retracted, the operator may adjust the height of the top portion 410 according to boating conditions and then release the handles 414 and 416 to allow the spring-biased pins 444 and 454 to reengage with the pin-based portions 440 and 450. In some embodiments, the pin-based portions 440 and 450 may include push fit ball plungers made of stainless steel or any other suitable material.

It should be noted that the present invention may include additional embodiments that combine one or more of the features, structures, or operations of the foregoing embodiments. For instance, certain embodiments may not only include motors for automatically raising and lowering gunnel pads, but such embodiments may also include spring-biased pins and handles for manually raising and lowering gunnel pads. In such embodiments, it may be possible to, for example, manually raise and lower the gunnel pad if the motors become inoperative. Similarly, other embodiments of the invention may include a combination of the tiered gunnel pad shown in FIG. 3 and the spring-based gunnel pad shown in FIGS. 4a-4b. Further, the phrase “extention/retraction portion,” as used herein, may refer to any device or combination of devices capable of enabling the raising or lowering of a gunnel pad top portion. For instance, in certain embodiments, an extension/retraction portion may include one or more of, or combination of, the motors, tiered portions, or pin-based portions discussed in FIGS. 2, 3, and 4, respectively. Accordingly, it should be appreciated that the present invention is not limited to the embodiments specifically described herein.

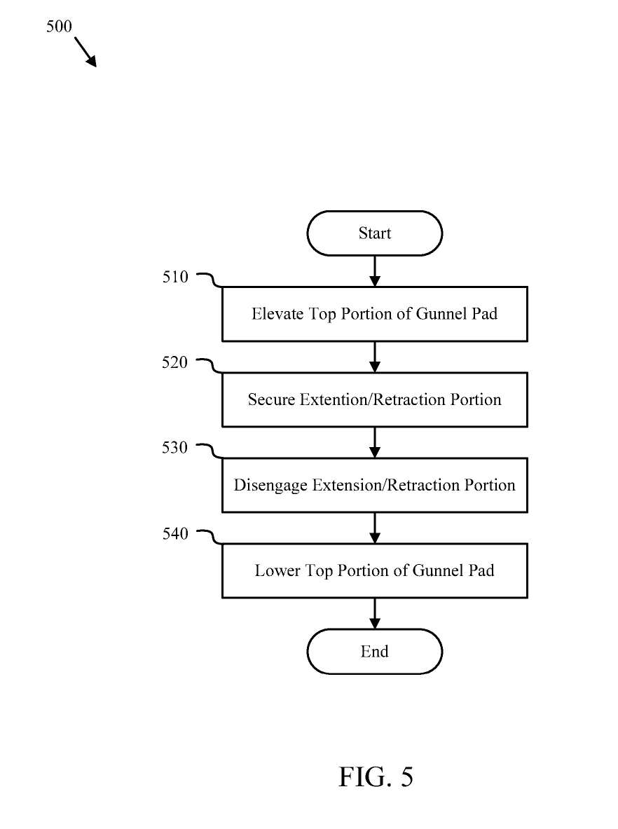

FIG. 5 is a flow chart diagram of a gunnel pad adjustment method 500 in accordance with one or more embodiments of the present invention. The method 500 includes elevating 510 a top portion of the boat gunnel pad, securing 520 an extension/retraction portion, disengaging 530 the extension/retraction portion, and lowering 540 the top portion of the boat gunnel pad. In certain embodiments, the method 500 may correspond to any of the gunnel pads depicted in the foregoing Figures.

In certain embodiments, a boat operator may elevate 510 a top portion of a boat gunnel pad by activating, engaging, or otherwise manipulating the extension/retraction portion (s) of the boat gunnel pad. In some embodiments, the operator may do this by activating one or more gunnel pad motors. In other embodiments, the operator may do this by manually applying an upward force or pressure on the top portion. In still other embodiments, the operator may manipulate one or more pins to do so. In such embodiments, the pins may be stand-alone pins, spring-biased pins, and/or pins connected to one or more handles.

In certain embodiments, securing 520 the extension/retraction portion may include deactivating one or more gunnel pad motors. In other embodiments, securing 520 the extension/retraction portion may include discontinuing the operator-generated, upward force on the top surface of the gunnel pad. In still other embodiments, securing 520 the extension/retraction portion may include reinserting a stand-alone pin into the extension/retraction portion, allowing a spring-biased pin to reinsert into the extension/retraction portion, or releasing the pressure on one or more gunnel pad handles.

In some embodiments, disengaging 530 the extension/retraction portion may include operations that effectively undo the work performed in securing 520 the extension/retraction portion. In certain embodiments, disengaging the extension/retraction portion may include reengaging one or more gunnel pad motions. In other embodiments, disengaging the extension/retraction portion may also include applying an operator-generated, downward force on the top surface of the gunnel pad. In other embodiments, disengaging the extension/retraction portion may include manually or mechanically removing a pin from the extension/retraction portion.

Lowering 540 the top portion of the gunnel pad may similarly include a variety of operations. In some embodiments, lowering 540 the top portion of the gunnel pad may include activating one or more gunnel pad motors. In other embodiments, lowering 540 the top portion of the gunnel pad may include maintaining an operator-generated, downward force on the top portion or allowing gravity to lower the top portion. Once, lowered, the top portion may be flush with the corresponding boat gunnel and, in some embodiments, may be secured in place by one or more operations that are similar no those described with the foregoing securing operation 520.

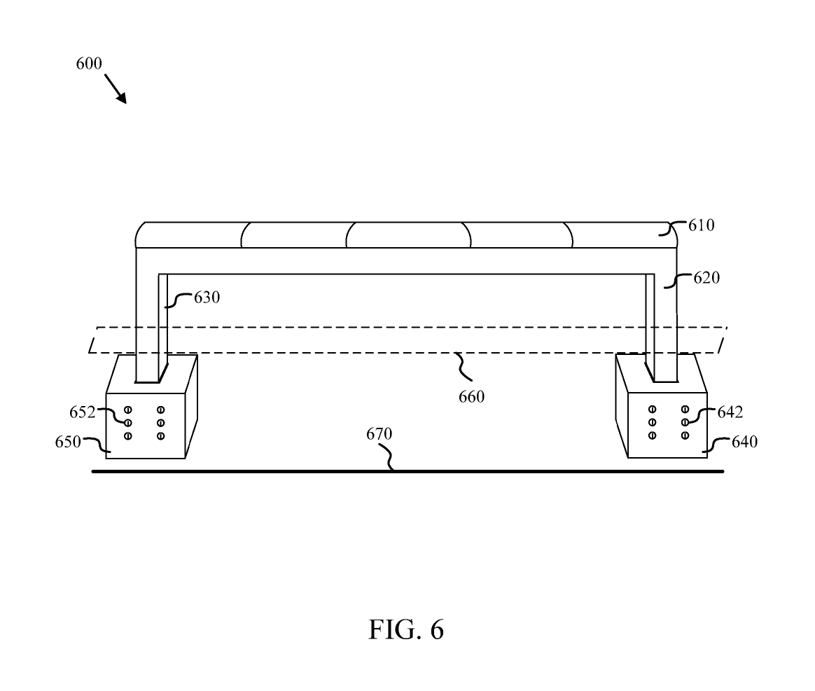

FIG. 6 is a perspective view of an after-market gunnel pad 600 in accordance with one or more embodiments of the present invention. It should be appreciated that one or more of the gunnel pads illustrated in FIGS. 1a-4b may be pre-market gunnel pads (i.e., gunnel pads that are installed during a boat's initial construction). However, FIG. 6 illustrates that the present invention also includes after-market gunnel pads and after-market gunnel pad installation methods.

Similar to the embodiment depicted in FIG. 2, the after-market gunnel pad 600 may include a top surface 610, a first leg portion 620, a second leg portion 630, a first motor 640, and a second motor 650. Also, in an open or extended position, the top portion 610 may be several inches above the boat gunnel 660, and in a closed or retracted position, the top portion 610 may be flush with the boat gunnel 660. However, since the (gunnel pad 600 is installed after-market, the motors 640 and 650 may be attached or otherwise secured to or within the vertical wall of the gunnel by one or more screws, bolts, or other connecting devices, as shown by 642 and 652. In other embodiments, the motors 640 and 650 might similarly, or alternatively, be secured to the boat floor 670. While FIG. 6 relies upon a motorized gunnel pad for an installation example, these features and operations can similarly be applied to install any and all of the boat gunnel pads of the present invention. Accordingly, the present invention may be applied to after market boats (i.e., the present invention can be retro-fitted to previously manufactured boats) or may be integrated into boats at the time of their manufacture.

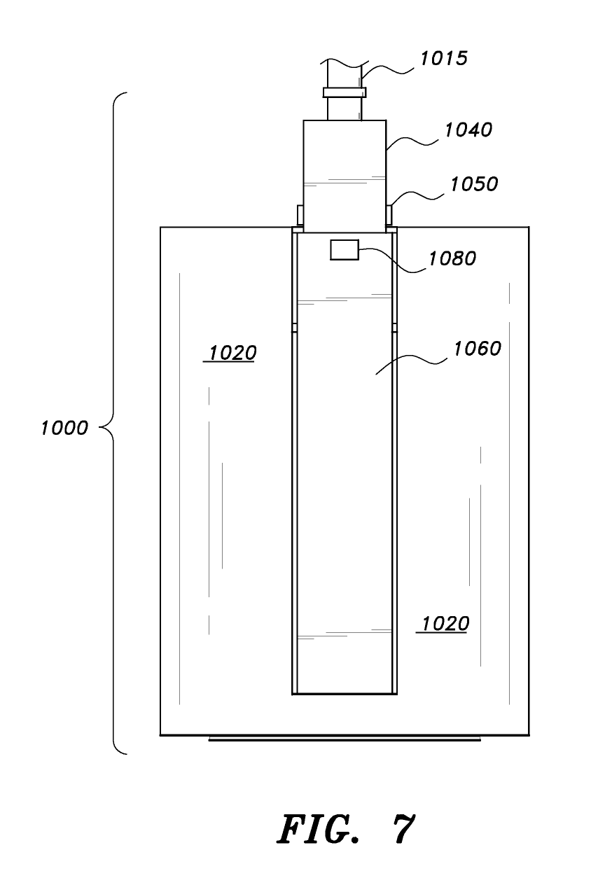

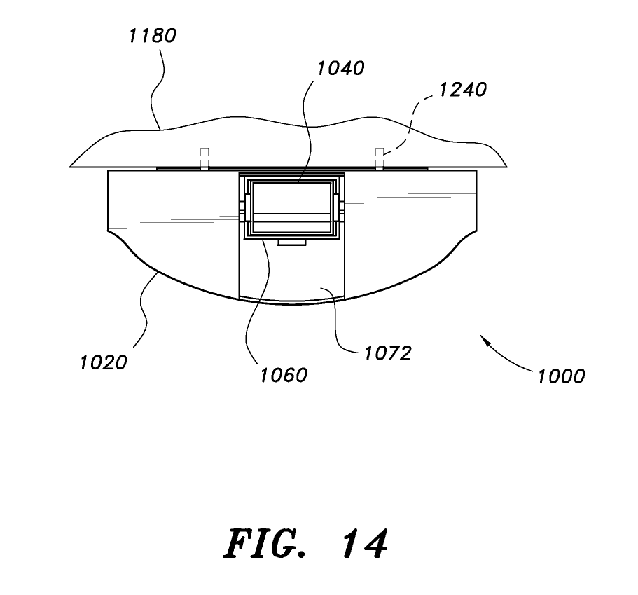

FIG. 7 shows a front view of a leg portion 1000 in accordance with one or more embodiments of the present invention. The leg portion 1000 includes a cover 1020 and an extension rod 1040. The extension rod is slidably engaged with respect to a receiving sleeve 1060. A locking plug 1050 is used to lock the extension rod 1040 in an up extended position and is depressed to allow the extension rod 1040 to slide downwards into the receiving sleeve 1060. The leg portion 1000 defines a bracket 1070 for accommodating receiving sleeve 1060; the bracket 1070 accommodates receiving sleeve 1060 and hence extension rod 1040 located inside receiving sleeve 1060; more specifically, the bracket 1070 defines a recess channel 1072 (shown in FIG. 14) for accommodating the receiving sleeve 1060 and hence the extension rod 1040 located therein. An additional locking plug 1080 may also be used to lock the extension rod 1040 in a desired up or down position with respect to the receiving sleeve 1060.

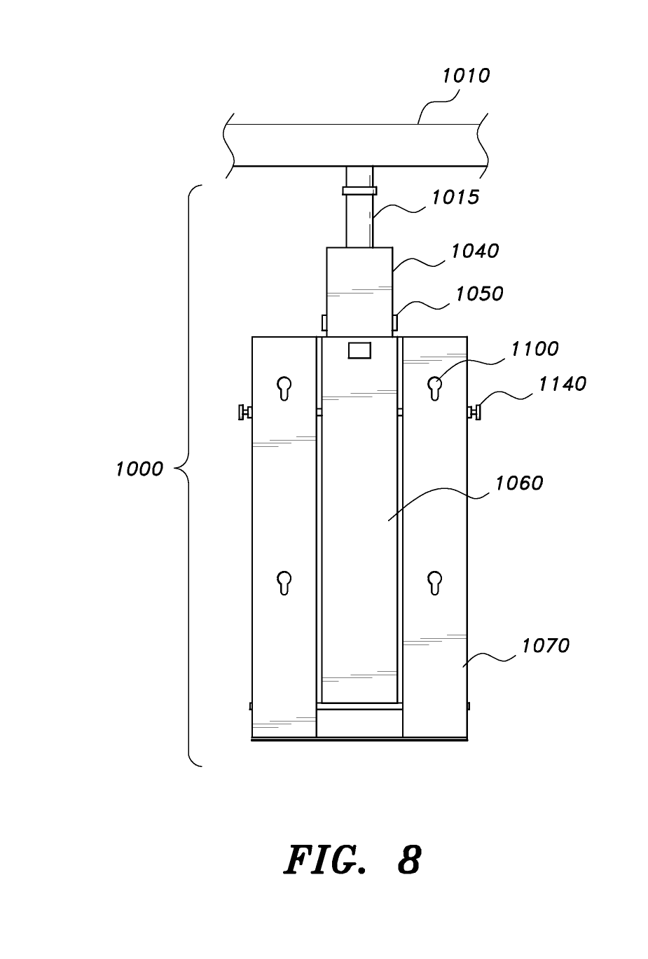

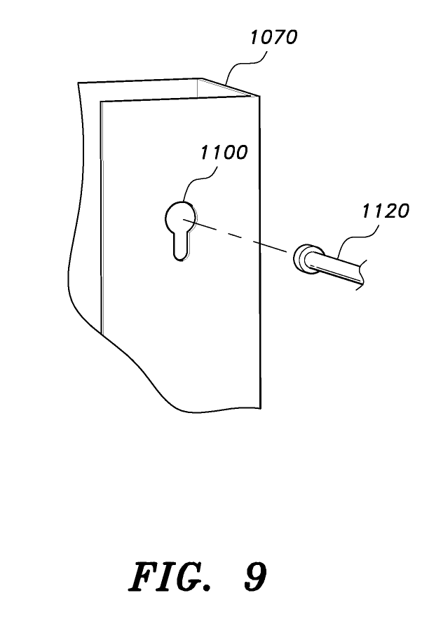

FIG. 8 shows the leg portion 1000 of FIG. 7 connected to a top portion 1010 via a support rod 1015. Support rod 1015 can be rotated 360° in the horizontal plane and swiveled in the vertical plane. In FIG. 7 the cover 1020 is removed in to reveal the interior of the leg portion 1000. The bracket 1070 includes a plurality of locking key holes 1100. The locking key holes 1100 are used to secure the cover 1020 to the bracket 1070 of leg portion 1000 as shown in FIG. 9. More specifically, the interior of the cover 1020 is populated with cover locking pins 1120 (shown in FIG. 9) which align with locking key holes 1100. The cover 1020 can be freed from the cover locking pins 1120 by a human operator by means of a lifting and pulling action.

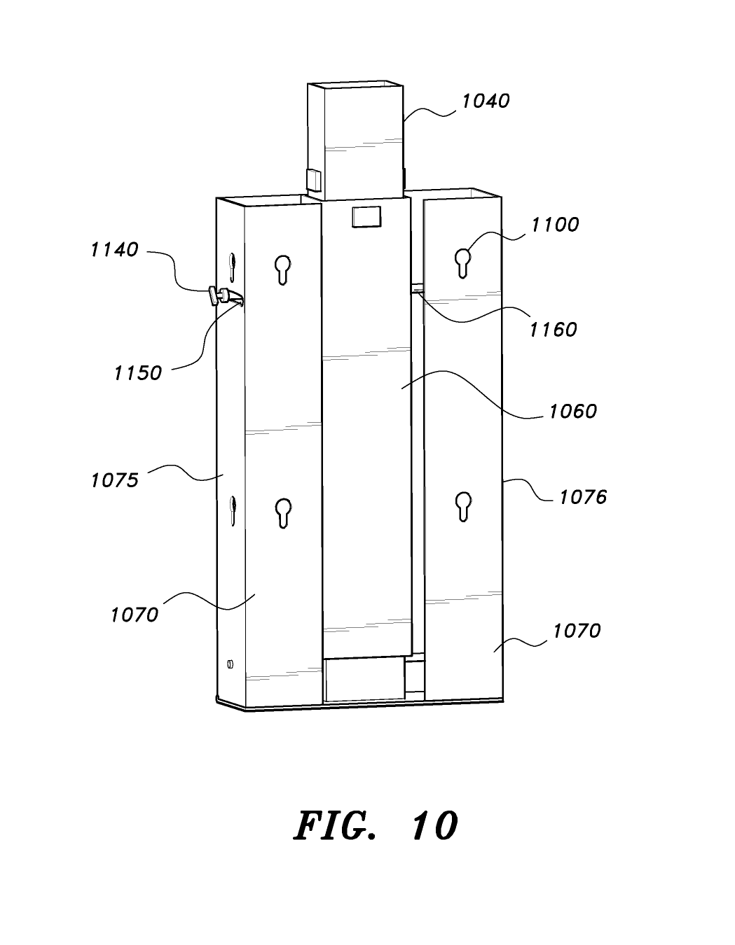

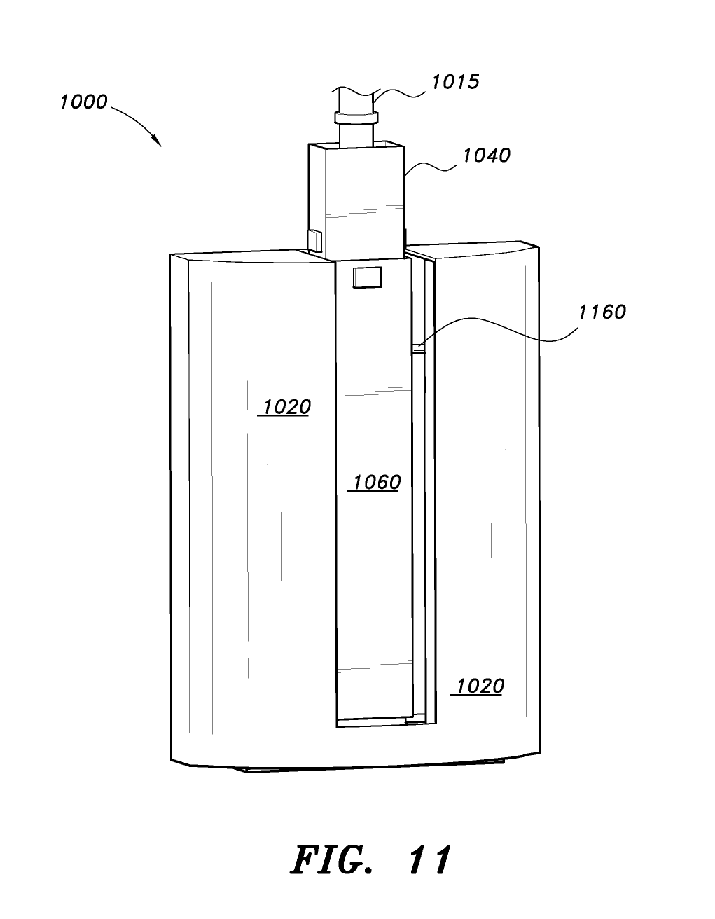

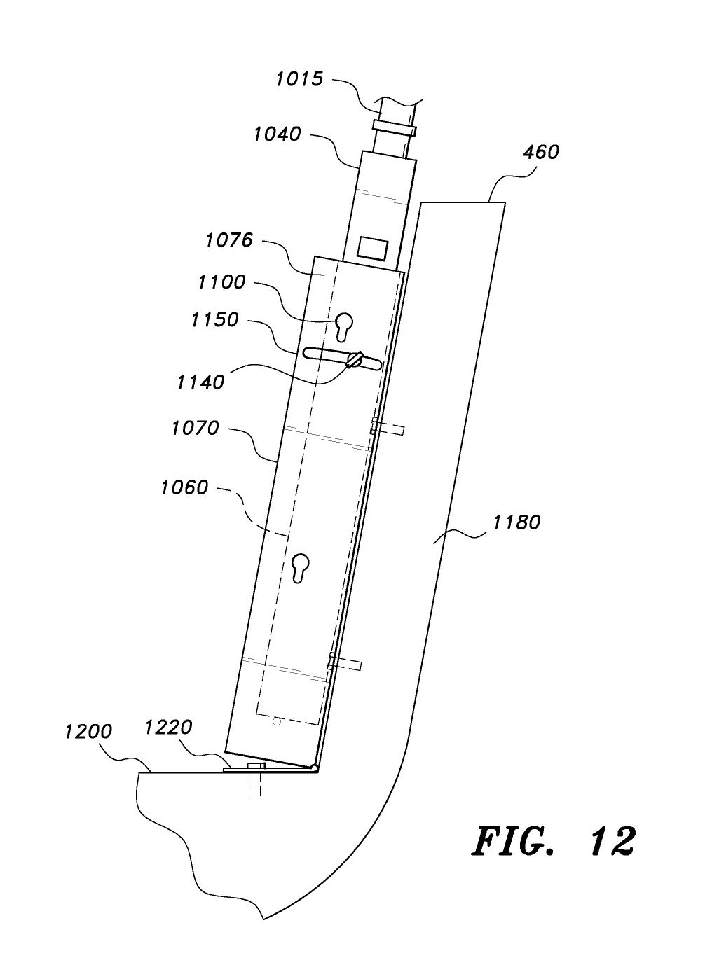

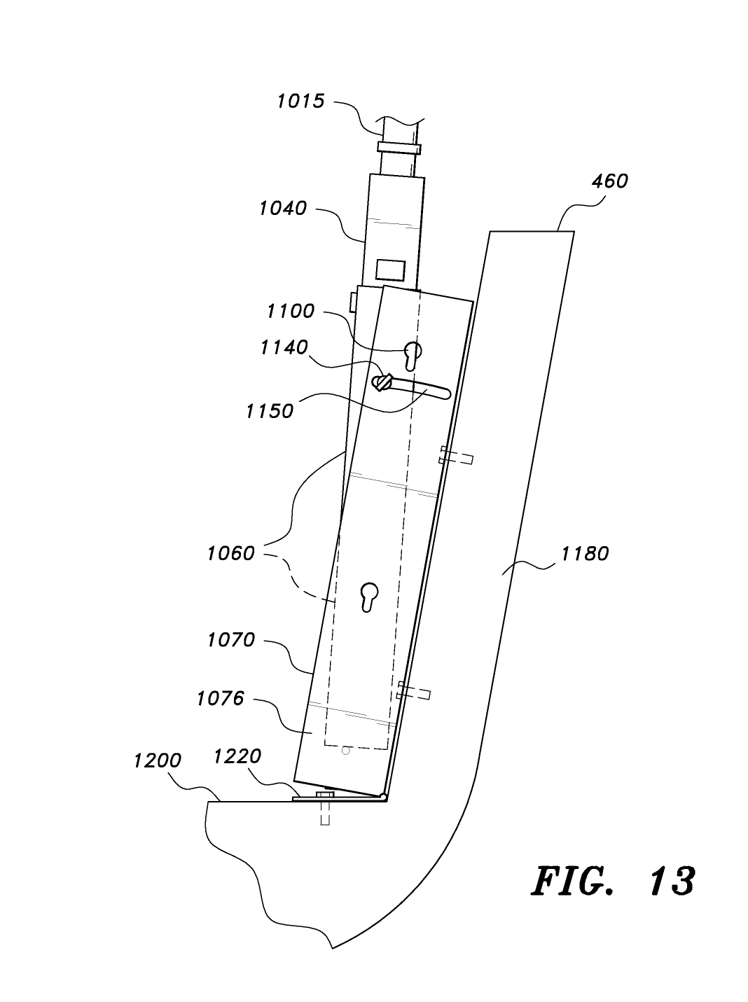

Referring to FIGS. 10 through 13, the receiving-sleeve locking pins 1140 are used to adjust the vertical orientation of the receiving sleeve 1060. The receiving-sleeve locking pins 1140 comprise a shaft 1160; the shafts 1160 connect the receiving-sleeve locking pins 1140 to the receiving sleeves 1060. FIG. 11 shows a cover 1020 fitted to the leg portion 1000 of FIG. 10. FIGS. 12 and 13 show how the receiving-sleeve locking pins 1140 are used to adjust the vertical attitude of the receiving sleeve 1060, and hence the extension rod 1040 located therein, with respect to the side 1180 or bottom 1200 of a boat. More specifically, the opposite sides 1075 and 1076 of bracket 1170 including slots 1150 for receiving-sleeve locking pins 1140 for securing receiving sleeve 1060. A hinge 1220 is used to accommodate attitude adjustment of receiving sleeve 1060.

FIG. 14 shows a top view of a leg portion 1000 in accordance with one or more embodiments of the present invention. The leg portion 1000 is shown secured to the sides of a boat by means of leg portion securing bolts 1240. It should be understood that the term “sides of a boat” can refer to the port, starboard and/or stern sides of a boat.

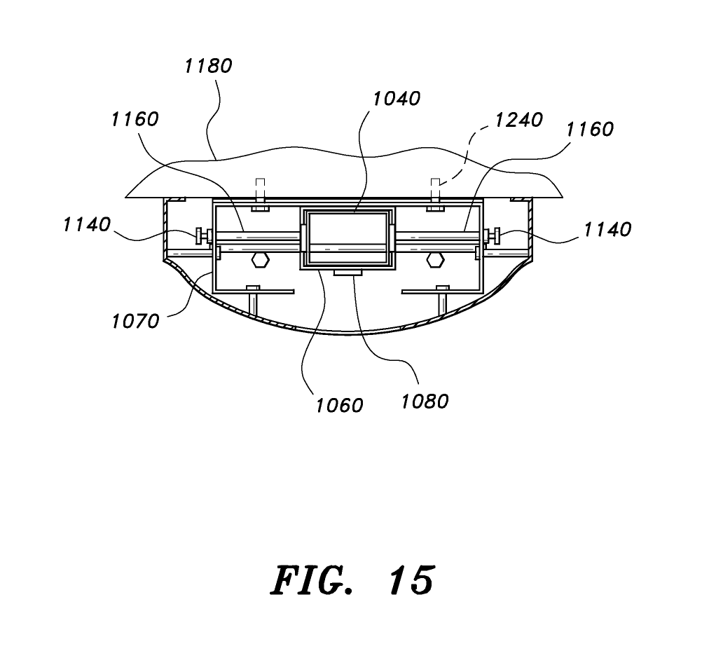

FIG. 15 shows a partially cut-away top view of a leg portion 1000 in accordance with one or more embodiments of the present invention.

It should be understood that the extension rod 1040 can have any cross-section shape such as circular cross-section, regular polygonal cross-section, square cross-section, rectangular cross-section or irregular polygonal cross-section. Likewise with respect to the receiving sleeve 1060, i.e., the receiving sleeve 1060 can have any cross-section shape such as circular cross-section, regular polygonal cross-section, square cross-section, rectangular cross-section or irregular polygonal cross-section. The extension rod 1040 can be manually extended from or re-inserted back into the receiving sleeve 1060; thus, the extension rod 1040 can telescope from the receiving sleeve 1060.

It should be appreciated that the embodiments of the present invention are not limited to those specifically described above. For instance, the apparatuses of the present invention may include different structures, features, or characteristics than those described above. Similarly, the methods of the present invention may include different operations, steps, or sequences than those described above. Therefore, it is to be understood that the present invention is not limited to the embodiments described above, but encompasses any and all embodiments within the scope of the following claims.

1. An apparatus, comprising:
a top portion of a boat gunnel pad;
a first leg portion comprising a first extension/retraction portion; and
a second leg portion comprising a second extension/retraction portion,
wherein the first leg portion and the second leg portion are connected via the top portion.

2. The apparatus of claim 1, wherein the first extension/retraction portion comprises a first motor and the second extension/retraction portion comprises a second motor.

3. The apparatus of claim 1, wherein the first extension/retraction portion comprises a first tiered portion and the second extension/retraction portion comprises a second tiered portion.

4. The apparatus of claim 1, wherein the first extension/retraction portion comprises a first pin-based portion and the second extension/retraction portion comprises a second pin-based portion.

5. The apparatus of claim 1, wherein the first extension/retraction portion and the second extension/retraction coition are connected to the boat gunnel.

6. The apparatus of claim 1, wherein the first extension/retraction portion and the second extension/retraction portion are connected to a boat floor.

7. The apparatus of claim 1, further comprising:
a first handle configured to activate the first extension/retraction portion and a second handle configured activate the second extension/retraction portion.

8. A method, comprising:
elevating a top portion of a boat gunnel pad;
securing an extension/retraction portion of the boat gunnel pad;
disengaging the extension/retraction portion of the boat gunnel pad; and
lowering the top portion of the boat gunnel pad.

9. The method of claim 8, wherein the elevating of the to portion of the gunnel pad comprises activating a motor of the boat gunnel pad.

10. The method of claim 8, wherein the elevating of the top portion of the gunnel pad comprises applying an operator-generated, upward force on a tiered portion of the boat gunnel pad.

11. The method of claim 8, wherein the elevating of the top portion of the gunnel pad comprises removing a spring-biased pin from a pin-based portion of the boat gunnel pad.

12. The method of claim 8, wherein the securing of the extension/retraction portion comprises deactivating a motor of the boat gunnel pad.

13. The method of claim 8, wherein the securing of the extension/retraction portion comprises eliminating an operator-generated, upward force on the tiered portion of the boat gunnel pad.

14. The method of claim 8, wherein the securing of the extension/retraction portion comprises reintroducing a spring-biased pin into a pin-based portion of the boat gunnel pad.

15. The method of claim 8, wherein the securing of the extension/retraction portion comprises the use of one or more gunnel pad handles operatively connected to a pin in a pin-based portion of the boat gunnel pad.
